(19) United States
(12) Patent Application Publication
(10) Pub. No.: US 2016/0025062 A1
(43) Pub. Date: Jan. 28, 2016

(54) WATER TURBINE

(71) Applicant: Andritz Hydro GmbH, Vienna (AT)

(72) Inventors: Josef MICHELCIC, Perg (AT); Markus KRAGL, Linz (AT); Evgenia KONTOLEONTOS, Linz (AT); Erwin OBERBICHLER, St. Martin (AT); Simon WEISSENBERGER, Ottensheim (AT)

(21) Appl. No.: 14/804,432

(22) Filed: Jul. 21, 2015

(30) Foreign Application Priority Data
Jul. 24, 2014 (AT) A-588/2014

(51) Int. Cl. F03B 3/10

(52) U.S. Cl. CPC F03B 3/103

(57) ABSTRACT

A water turbine, such as a pump turbine, includes an impeller and a guide wheel that are adjustable. By adjusting the angles of the impeller blades or the guide vanes, such as beyond a range of 180 degrees and 90 degrees, respectively, the water turbine may be adjusted to switch between power generation and pumping, and for tidal flow.

### RELATED APPLICATION

This application claims priority to Austrian application number A 588/2014 filed 24 Jul. 20149, the entirety of which is incorporated by reference.

### BACKGROUND

The invention relates to a water turbine, especially a pump turbine, with an impeller and a guide wheel.

Pumps turbines are often used in pumped storage power stations and have poor efficiency because they have to operate in both directions and the efficiency has to be sized optimally for the overall turbine and pump operations. In order to make use of energy from the sea, axial turbines are used in the same way as in run-of-river power stations. In order to enhance tidal flows, systems are built with large basins that are filled by pumps and form a reservoir. For optimum use of tidal currents, the turbine must operate in both directions. In order to have optimum efficiency for turbine and pump operations, U.S. Pat. No. 4,275,989, for example, suggested arranging the entire turbine with the guide wheel in a unit that can be swung through 180°. However, this is only feasible for small units.

### SUMMARY OF INVENTION

An aim of the invention is to create a turbine that can operate in both directions with optimum efficiency and can also be used as a pump.

A novel turbine has been invented and is disclosed herein having blades of an impeller and vanes of a guide wheel that are adjustable. In this way, optimum efficiency can be achieved for both turbine and pump operation.

A favorable development of the novel turbine is that the turbine maybe a bulb turbine. Thus, optimum use can be made of the flow, particularly the tidal flow.

An advantageous embodiment of the novel turbine has impeller blades that maybe adjusted to have an impeller blade angle larger than 180 degrees. Due to this setting, it is always possible to achieve optimum turbine efficiency, even if the water is flowing in the opposite direction, as is the case with tidal flows.

An advantageous development of the novel turbine invention is characterized in that the guide vane angle can be set larger than 90°. In combination with the large impeller blade angle, the turbine efficiency is particularly good when operating in reverse direction.

### SUMMARY OF DRAWINGS

The invention will now be exemplified on the basis of the drawings, where

FIG. 1 shows a known arrangement of a turbine using the invention, and

FIG. 2 shows an application of the turbine according to the invention, operating in reverse direction in a tidal power station.

### DETAILED DESCRIPTION OF INVENTION

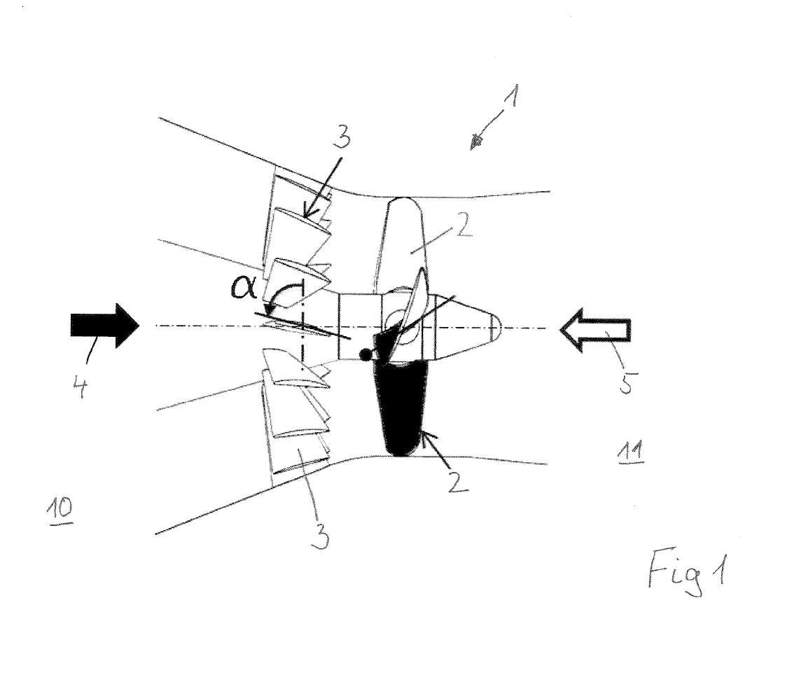

FIG. 1 shows an arrangement of a turbine 1 according to the invention, which is exemplified here as a bulb turbine. In normal operation, for example, the headwater 10 is on the left-hand side of the figure and the tailwater 11 on the right. Water flows in the direction of the arrow 4 from the headwater 10 over the guide wheel with guide vanes 3 to the impeller with impeller blades 2 into the tailwater 11 and causes the turbine to rotate.

The angle setting of the impeller blades 2 and the guide vanes 3 is similar to the setting in a conventional Kaplan bulb turbine. In order to achieve optimum efficiency, the setting angle β of the impeller blades 2 varies between 0° and 40°. Similarly, the setting angle α of the guide vanes 3 is set between 0° and less than 90°. The setting angles β and α are with respect to an axis of the turbine and a line between a leading and trailing edge of the blade or impeller. Further, the setting angel may be with respect to a radially inward portion of the blade or impeller such as proximate to the hub of the turbine.

In pump operations, the water flows in the direction of the arrow 5 from the tailwater 11 over the impeller with impeller blades 2 through the guide wheel with guide vanes 3 into the headwater 10. Here, too, the setting angle β of the impeller blades 2 varies between approximately 0° and 40°. In the same way, the angle α of the guide vanes 3 is set between 0° and less than 90°.

Now a concept with a reservoir has been developed for a tidal power station. At high tide, the water from the sea (corresponding to the head water 10) flows through the turbine 1 into the reservoir (corresponding to the tailwater 11).

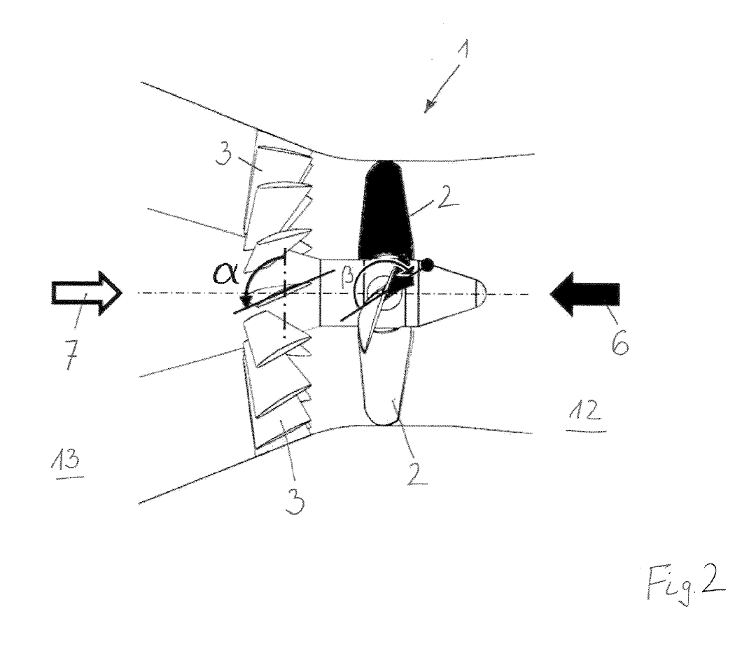

At low tide, reverse operation as shown in FIG. 2 is applied. Here, the water flows in the direction of the arrow 6 out of the reservoir (corresponding to the headwater 12) through the turbine 1 (impeller with impeller blades 2 and guide wheel with guide vanes 3) back into the sea (corresponding to the tailwater 13). For this purpose, the angle β of the impeller blades 2 is set to more than 180°, and the guide vanes 3 must also overdrive here and set an angle α of more than 90°. For this purpose, adjusting devices are also needed for the impeller blades 2 to enable a setting angle β of this type greater than 180°. In order to achieve optimum efficiency, a setting angle β of up to 220° is selected.

In pump operations, the water then flows in the direction of the arrow 7 from the tailwater 13 through the turbine 1 with guide vanes 3 and impeller blades 2 into the headwater 12.

It has been shown that the potential of the tides can be put to better use by means of additional pumping.

Especially with an impeller blade 2 setting at an angle β of more than 180° and the guide vanes 3 at a setting angle α of more than 90°, the turbine can also be operated with optimum efficiency in reverse direction, i.e. in a tidal power station at low tide. Effective operation in both directions of flow is only possible with this bi-directional pump turbine, thus making it possible to use additional energy potential from the sea.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise.

We claim:

1. A water turbine comprising:
an impeller and a guide wheel, and
blades of the impeller and vanes of the guide wheel are adjustable.

2. The water turbine according to claim 1, wherein the turbine is a bulb turbine.

3. The water turbine according to claim 1, wherein an impeller blade angle β can be set larger than one hundred eighty degrees.

4. The water turbine according to claim 1, wherein a guide vane angle α can be set larger than ninety degrees.

5. The water turbine of claim 1 wherein the water turbine is a pump turbine.
